(19) United States
(12) Patent Application Publication
(10) Pub. No.: US 2024/0347331 A1
(43) Pub. Date: Oct. 17, 2024

(54) INTENSITY-INDEPENDENT PRECURSOR INFERENCE IN MASS SPECTROSCOPY

(71) Applicant: DH Technologies Development Pte. Ltd., Singapore (SG)

(72) Inventors: Gordana IVOSEV, Etobicoke (CA); Nic BLOOMFIELD, Newmarket (CA)

(73) Assignee: DH Technologies Development Pte. Ltd., Singapore (SG)

(21) Appl. No.: 18/682,218

(22) PCT Filed: Aug. 10, 2022
(86) PCT No.: PCT/IB2022/057480

§ 371 Date: Feb. 8, 2024

Related U.S. Application Data
(60) Provisional application No. 63/232,452, filed on Aug. 12, 2021.

(51) Int. Cl. H01J 49/00

(52) U.S. Cl. CPC H01J 49/0045

(57) ABSTRACT

Methods for correlating a product ion in a mass spectrum to a precursor ion are disclosed herein, comprising determining a precursor ion ml z corresponding to the product ion as an m/z at which the product ion appears in a maximum amount of the series of mass spectra. Methods also can comprise obtaining a series of mass spectra for a sample across a mass range, each of the series of mass spectra having a precursor ion transmission window defined by a width (W) that overlaps with that of at least two of the series of mass spectra by a step size (S).

### CROSS-REFERENCE TO RELATED APPLICATION

This application is being filed on Aug. 10, 2022, as a PCT International Patent Application and claims priority to and the benefit of U.S. Provisional Application No. 63/232,452, filed on Aug. 12, 2021, which application is hereby incorporated by reference in its entirety.

### BACKGROUND

Sequential window acquisition of all theoretical mass spectra (SWATH) mass spectrometry methods are known for identification of components within complex protein mixtures. For instance, SWATH methods have been applied in proteomics, to identify individual proteins according to their mass within complex biological samples containing hundreds or thousands of different proteins and other biologic species. In tandem mass spectrometry methods, a first quadrupole implemented as a mass filter continually samples a desired mass range as a series of overlapping segments within the mass range, such that each of the product ions generated and observed in a second quadrupole can be associated with a product in the original sample. This iterative scanning process returns enormous amounts of data and conventionally, analysis of the acquired data has required demanding processing of the data to correlate each product ion detected with both a precursor giving rise to the product ion, and an intensity of the product ion relative to its concentration in the sample.

Overlapping precursor ion peaks or product ion peaks complicate the analysis of the acquired data, and can result in shifting of precursor peaks, or appearance of noise as additional precursor peaks not actually present.

### SUMMARY

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

Disclosed herein are methods for correlating a product ion in a mass spectrum to a precursor ion. In certain aspects, methods can comprise obtaining a series of mass spectra for a sample across a mass range, each of the series of mass spectra having a precursor transmission window defined by a width (W) that overlaps with that of at least two of the series of mass spectra by a step size(S), and determining a precursor ion m/z corresponding to the product ion as an m/z at which the product ion appears in a maximum amount of the series of mass spectra.

In other aspects, methods for generating mass spectrometry data are disclosed, and can comprise moving a precursor ion transmission window with precursor ion mass-to-charge ratio (m/z) width W in overlapping steps across a precursor ion mass range with a step size S m/z using a mass filter of a tandem mass spectrometer, thereby producing a series of overlapping transmission windows across the mass range, wherein the mass filter transmits precursor ions within the transmission window at each overlapping step. Such aspects can further comprise fragmenting or transmitting the precursor ions transmitted at each overlapping step by the mass filter using a fragmentation device of the spectrometer, thereby producing one or more resulting product ions for each overlapping window of the series.

Aspects disclosed herein can further comprise detecting intensities or counts for each of the one or more resulting product ions for each overlapping window of the series that form a series of mass spectra, each of the series of mass spectra corresponding to one of the series of overlapping transmission windows, determining a precursor ion m/z of at least one of the one or more resulting product ions, wherein the precursor ion m/z is the m/z at which the product ion appears in a maximum amount of the series of mass spectra arising from each of the series of overlapping transmission windows across the mass range, and calculating an intensity for each of the one or more resulting product ions by applying the precursor ion m/z of the product ion to the detected intensities or counts.

Tandem mass spectrometry systems are also contemplated herein, and can comprise (i) a mass filter of a tandem mass spectrometer that moves a precursor ion transmission window with precursor ion mass-to-charge ratio (m/z) width W in overlapping steps across a precursor ion mass range with a step size S m/z, producing a series of overlapping transmission windows across the mass range, wherein the mass filter transmits precursor ions within the transmission window at each overlapping step, (ii) a fragmentation device of the spectrometer that fragments or transmits the precursor ions transmitted at each overlapping step by the mass filter, producing one or more resulting product ions for each overlapping window of the series, (iii) a mass analyzer of the spectrometer that detects intensities or counts for each of the one or more resulting product ions for each overlapping window of the series that form mass spectrum data for each overlapping window of the series, and (iv) a processor that, instead of storing the mass spectrum data for each overlapping window of the series in a memory device, encodes each unique product ion detected by the mass analyzer in real-time during data acquisition by (a) determining a precursor ion m/z for each unique product ion as the m/z at which the product ion appears in a maximum amount of the series of mass spectra arising from each of the series of overlapping transmission windows, and (b) determining an intensity associated with the unique product ion.

Both the foregoing summary and the following detailed description provide examples and are explanatory only. Accordingly, the foregoing summary and the following detailed description should not be considered to be restrictive. Further, features or variations may be provided in addition to those set forth herein. For example, certain aspects and examples may be directed to various feature combinations and sub-combinations described in the detailed description.

### BRIEF DESCRIPTION OF THE DRAWINGS

FIG. 1 is a schematic showing a tandem mass spectrometry system for performing real time precursor inference on mass spectrometry samples, in accordance with certain examples disclosed herein.

FIG. 2 is a diagram showing how each unique product ion detected is encoded in real-time during scanning SWATH data acquisition, in accordance with certain examples disclosed herein.

FIG. 3 is a flowchart representation of methods for performing real time precursor inference, in accordance with certain examples disclosed herein.

FIG. 4 is a flowchart representation of methods for generating mass spectrometry data, in accordance with certain examples disclosed herein.

FIG. 5A is a graph demonstrating data collected from the precursor ion transmission windows of a mass filter quadrupole, where the peaks from precursors A and B are slightly overlapped in the observed intensity trace.

FIG. 5B is a representation of the data obtained in FIG. 5A, in which the precursor ion transmission windows indicate the presence of precursor A (dots), the presence of precursor B (crosses), or the presence of both (dots and crosses).

FIG. 6A is a graph demonstrating data collected from the precursor ion transmission windows of a mass filter quadrupole, where the peaks from precursors A and B are completely overlapped in the observed intensity trace.

FIG. 6B is a representation of the data obtained in FIG. 6A, in which the precursor ion transmission windows indicate the presence of precursor A (dots), the presence of precursor B (crosses), or the presence of both (dots and crosses).

### DETAILED DESCRIPTION

Tandem mass spectrometry systems and methods are described herein. In certain aspects systems and methods are configured to correlated product peaks observed in mass spectra to their appropriate precursors. Methods disclosed herein can greatly reduce the amount of memory and processing power required compared to conventional methods. Methods disclosed herein also may greatly improve the ability to deconvolute precursor ion peaks that show significant overlap in the corresponding intensity trace.

Methods disclosed herein may be performed on any systems suitable to carry out the methods, and are not limited to any particular system or device, or combination thereof. In various examples, systems disclosed herein can further comprise a sample introduction device. Sample introduction devices can be configured to introduce one or more compounds of interest from a sample to ion source device. In certain aspects, a sample introduction device can perform techniques that include, but are not limited to, injection, liquid chromatography, gas chromatography, capillary electrophoresis, or ion mobility spectrometry.

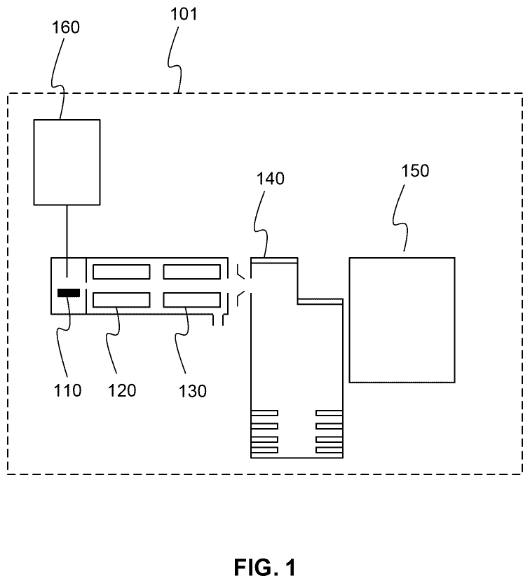

In certain aspects, suitable systems can comprise a tandem mass spectrometry system, comprising a sampling module, an ionization chamber, a mass filter, a fragmentation device, a mass analyzer, and a processor, or any combination thereof. FIG. 1 provides a schematic diagram showing one example of a such a system comprising precursor ion source device 110, mass filter 120, fragmentation device 130, mass analyzer 140, and processor 150.

In the system of FIG. 1, mass filter 120 and fragmentation device 130 are shown as different stages of a quadrupole and mass analyzer 140 is shown as a time-of-flight (TOF) device. One of ordinary skill in the art can appreciate that any of these stages can include these and other suitable mass spectrometry device including, but not limited to, ion traps, orbitraps, ion mobility devices, or Fourier transform ion cyclotron resonance (FT-ICR) devices.

Ion source device 110 can transform a sample or compounds of interest from a sample into an ion beam. Ion source device 110 can perform ionization techniques that include, but are not limited to, matrix assisted laser desorption/ionization (MALDI) or electrospray ionization (ESI).

Mass filter 120 is configured to receive the ion beam from ion source device 110, and transfer ions within a precursor ion mass range R to fragmentation device 130. Mass filter 120 can have a variable mass range R, such that a series of overlapping precursor ion transmission windows can be generated. Mass filter 120 transmits precursor ions within the transmission window at each overlapping step. For instance, in certain aspects, each transmission window within a series can have a precursor ion mass-to-charge ratio (m/z) width W in overlapping steps across a precursor ion mass range of R m/z with a step size S m/z. Window width W and step size S also can be variable.

Fragmentation device 130 of tandem mass spectrometer 101 can receive and fragment the precursor ions transmitted from mass filter 120, and further transmit ions to mass analyzer 140. Fragmentation device 130 generates product ions from the filtered precursor ions, and resulting product ions are produced for each overlapping window of the series. As will be understood by those in the art, fragmentation device 130 fragments a given ion only when a fragmentation energy is sufficiently high under the fragmentation conditions. Therefore, the ion mixture transmitted from fragmentation device 130 to mass analyzer 140 can contain both unfragmented precursor ions and fragmented product ions.

Mass analyzer 140 of tandem mass spectrometer 101 detects intensities or counts for each of the one or more resulting product ions for each overlapping window of the series that form mass spectrum data for each overlapping window of the series. Mass analyzer also provides a second separation of ions such that ions transmitted from fragmentation device 130 are separated and individually detected. In certain aspects, mass analyzer 140 can be a TOF device that separates and detects ions based on counts of ions at every m/z across the full range of m/z of the sample transmitted from the fragmentation device 130. In other aspects, mass analyzer 140 can be a second quadrupole, detecting intensities of ions at each given m/z across the transmission window.

Processor 150 can be, but is not limited to, a computer, a microprocessor, the computer system of FIG. 1, or any device capable of sending and receiving control signals and data from a tandem mass spectrometer and processing data. Processor 150 is shown in communication with ion source device 110, mass filter 120, fragmentation device 130, and mass analyzer 140. Processor 150 is shown as a separate device within tandem mass spectrometer 101, but also can be disposed independently, as an independent device interacting with the components of tandem mass spectrometer 101.

Systems disclosed herein are not limited to storing the mass spectrum data for each overlapping window of the series in a file in a memory device. In certain aspects, processor 150 can perform an encoding and storing step, such that the cumulative mass spectrum data for each overlapping window can be discarded. Encoding the mass spectrum data in this manner greatly reduces the processing and storage requirements for methods disclosed herein. In certain aspects, processor 150 can encode and store each unique product ion detected by mass analyzer 140 in real-time during data acquisition, generating a list of product ions correlated to a precursor in the sample from the raw mass spectral data.

Methods for acquiring and processing tandem mass spectrometry data are desired to reduce the processing demand, with increased accuracy and sensitivity. It is also desirable that such methods be available for processing data in real time, or post-acquisition. Methods able to faithfully deconvolute overlapping peaks within obtained or processed data are also desired.

Methods for generating mass spectrometry data and correlating a product ion in a mass spectrum to a precursor ion m/z are also contemplated herein. In certain aspects, methods disclosed herein can comprise obtaining a series of mass spectra for a sample across a mass range. Methods disclosed herein generally may be performed on a two-dimensional mass spectrometry system as described above, and can include sequential window acquisition methods. In such aspects, each of the series of mass spectra can have a precursor ion transmission window defined by a width (W) that overlaps with a precursor ion transmission window of at least two of the series of mass spectra by a step size(S). Such methods include, but are not limited to SWATH mass spectrometry, including Scanning SWATH mass spectrometry using a tandem mass spectrometer.

Obtaining a series of mass spectra as recited herein can comprise a first mass filtering step where a precursor ion mixture is filtered according to its m/z, followed by fragmentation of the precursor ion, a second m/z separation, and detecting the fragmented ions by a mass analyzer. Methods disclosed herein also can be applicable to alternative two-dimensional mass spectrometry methodologies giving rise to product ions and precursor ions are also contemplated herein. In certain aspects, methods disclosed herein can be performed on systems as exemplified by the schematic drawing of FIG. 1.

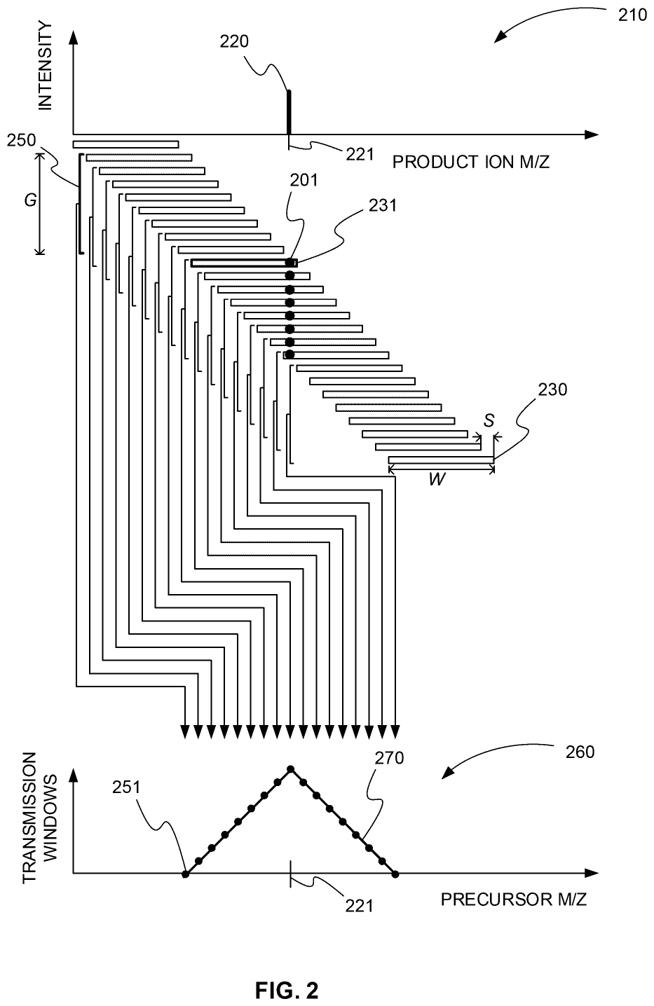

FIG. 2 presents a diagram showing an example of each unique product ion detected can be encoded in during scanning SWATH data acquisition, in accordance with various examples. Plot 210 shows that there is a product ion 220 at m/z 221 within a precursor ion mass range. A precursor ion transmission window 230 with an m/z width W is stepped with a step size S m/z across the mass range, producing a series of overlapping transmission windows. In FIG. 2, a first appearance of a unique product ion 201 occurs in first appearance overlapping window 231, for example.

Methods for processing Scanning SWATH mass spectrometry data generally can include real time encoding by creating a Q1 trace from binned ToF-spectra and encoding to the Q1 trace bins of some portion of the quadrupole filter window. The bin size and encoding window are designed to keep-up real time encoding with the acquisition within reasonable limitations on available memory cache and processing requirements.

Alternatively, ToF spectra can be streamed into a binary file tracking intensity of the observed peak for each product ion, and subsequently processed to create a precursor inference uncertainty probability density function (PIU pdf) to deconvolute degenerate peaks, post-acquisition. Generation of the PIU pdf in this manner preserves the data as obtained from the mass spectrometry methods, however, presents a relatively complex two-variable determination when deconvoluting intensity and precursor m/z from a single data set. In contrast, methods disclosed herein can determine intensity and precursor m/z separately, transforming the two-variable determination into two successive, and relatively simple, single variable determinations.

Methods disclosed herein can advantageously comprise processing steps following obtaining a series of mass spectra as described above. In certain aspects, methods described herein can comprise determining a precursor ion m/z corresponding to a product ion observed in at least one of the series of mass spectra. In certain aspects, the product ion can be identified as a fragment of a precursor having a particular m/z by determining the m/z at which the product ion appears in a maximum amount of mass spectra. Determination can be achieved by constructing a binary ion trace that identifies the amount of spectra in which the product ion appears, as a total, for a given m/z associated with each precursor ion transmission window.

Referring again to FIG. 2, binary ion trace 270 of plot 260 is shown having a triangular shape indicating a maximum following a sharp decrease at its peak, symmetrical with the preceding increase. In certain aspects, the binary ion trace can be constructed by grouping precursor ion transmission windows into successive groups (G) of transmission ion windows including a transmission windows 230 spanning with opening values of m/z spanning the width (W) of one transmission window. In such aspects, an amount of transmission windows 251 for a group 250 can be calculated as the number of windows in which product ion 201 appears. The transmission window 231 in which the product ion first appears is therefore included in eight separate groups (G), representing the positive slope portion of binary ion trace 270. mass range limited to the product spanning at least the width of the precursor, identifying a group 250 where a given product ion first appears.

In certain aspects, the amount of transmission windows in which a given product ion appears can be determined as either present or absent from the transmission window, and thus considered binary with respect to the data received from the detector. Those of skill in the art will understand that binary ion trace as employed herein is distinct from the accumulated counts received at the detector as discrete signals, which can number in the hundreds for a given m/z bin during obtaining a mass spectrum related to any given precursor ion transmission window.

As shown in FIG. 2, a triangular trace 270 resulting from generating binary trace 260 as described above provides a clear representation of the maximum by a triangular shaped maximum directly correlated to the precursor ion m/z. The triangular shape is a direct result of the constant step size across precursor ion transmission windows, and expected to maintain a similar, or identical, shape for each unique product ion observed in the mass spectra. In similar fashion, it will be understood that any manner of determining local maxima along the binary ion trace can be implemented as appropriate. For instance, maxima can be determined at points of inflection in a binary ion trace, where a positive slope along the binary ion trace returns to zero.

Those of skill in the art will recognize that other peak shapes can be obtained from the binary ion trace depending on transmission window width (W), step size(S), among other variables. In certain aspects, the step size(S) can be in a range from 0.1 Da to 10 Da, from 1 to 25 Da, or from 1 to 10 Da. In other aspects, the width (W) can be in a range from 10 to 250 Da, from 5 to 100 Da, or from 25 to 150 Da. In certain aspects the step size and width can be constant for each of the precursor ion transmission windows. In other aspects the series of mass spectra can comprise from 10 to 1,000 mass spectra.

Notably, binary trace 260 is completely independent from the intensity of the product ion detected. Generating plot 260 or an equivalent therefore allows the deconvolution of degenerate product ion peaks (e.g., product ions having the same m/z but arising from fragmentation of different precursor ions) by removing the intensity of each signal as a complicating variable. In this manner, the development of mass spectra for individual compounds within a sample can be transformed from a highly complex processing effort to make a two-variable determination into two a relatively straightforward one-variable determinations, (i) determining the intensity of product ions detected by the mass analyzer, and (ii) inferring the m/z of precursors ions giving rise to each product ion detected by the mass analyzer.

Methods disclosed herein can comprise generating a binary trace 260 as shown in FIG. 2. While this operation can be performed in real time, allowing the required stored data to be reduced, the ability of the binary ion trace to deconvolute peaks separate from an intensity trace allows for the processing time to deconvolute degenerate peaks to also be significantly reduced. It is also contemplated herein that the binary ion trace can be constructed from a minimum amount of data points, working backward from an expected predictable peak shape, to minimize the amount of data needed to be obtained, processed, and retained.

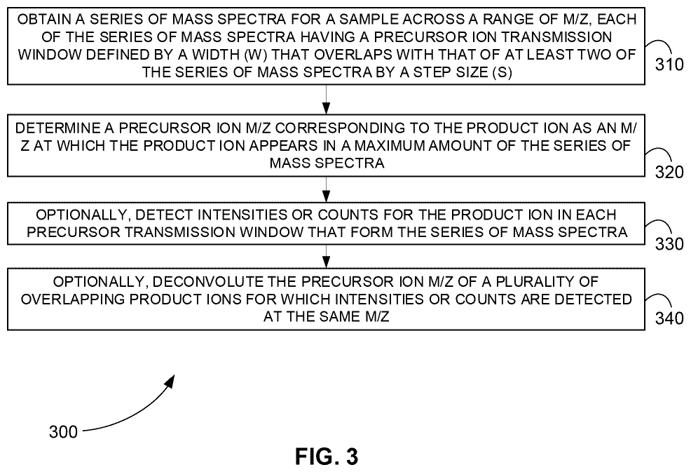

FIG. 3 provides a flowchart representation of method 300, in accordance with certain aspects disclosed herein. In operation 310, a series of mass spectra are obtained that represent the raw data produced by a SWATH methodology. Operation 320 represents an first step of the successive one-variable determinations described above, wherein the precursor ion m/z of a product ion is determined as the m/z at which the product ion appears in a maximum amount of the series of mass spectra.

Optionally, method 300 further comprises operations 330 and 340, where an intensity is associated with each product ion, and precursor ion. Each of operations 310, 320, 330, and 340 can be determined in real-time, from truncated data, or alternatively, from raw data obtained during the MS/MS acquisition, as a post-acquisition process. Notably, optional operation 330 is separate from the determination of the precursor ion m/z 320, so as to allow the determination of precursor m/z to remain independent of the intensity information gathered for each peak. However, separation of steps in the representation of FIG. 3 does not preclude further steps of rejoining intensity and precursor ion m/z in a single data entry or representation, once determined individually.

In aspects where intensity trace identifies overlapping peaks within the detected intensity trace, method 300 optionally can comprise deconvoluting the precursor ion m/z of a plurality of product ions having overlapping precursor ion m/z peaks in the PIU pdf, or binary ion trace. In certain aspects, methods can comprise assignment of the precursor ion m/z to peaks in an intensity trace, such as may be obtained by operation 330 of method 300. Each product ion can therefore be correlated to its appropriate precursor ion prior unambiguously, prior to correlation of intensity data to the product ion peaks.

In aspects where determining a precursor ion m/z results in a binary ion trace with overlapping precursor peaks, such peaks can be deconvoluted prior to correlating an intensity to the peaks as in operation 340. In such aspects, deconvoluting the overlapping precursor ion m/z peaks can comprise assigning a triangular shape to each observed peak to determine the number of overlapping peaks within a single overlapped signal, and identifying the corresponding maxima therein. As stated above, this deconvolution is aided by being independent of intensity information that can conflate deconvolution efforts with noise and shifting of peaks. Maintaining the binary ion trace as indication of the precursor m/z relating to a product peak separately from intensity information corresponding to the product peak allows operations 330 and 340 to be performed as one-variable determinations. Deconvoluting overlapping peaks can comprise deconvoluting two peaks, or three peaks, or more than three peaks. Precursors giving rise to the same m/z fragment ions can be deconvoluted by methods disclosed herein even where the m/z of each of the respective precursor ions differs by less than 50 Da, less than 25 Da, less than 10 Da, less than 5 Da, less than 1 Da, less than 0.1 Da, or less than 0.01 Da. Precursors giving rise to the same m/z fragment ions can be deconvoluted by methods disclosed herein even where the m/z of each of the respective precursor ions differs by less than five times the step size(S), less than 3 S, less than 2 S, less than 1 S, less than 0.1 S, or less than 0.01 S. Methods disclosed herein can comprise deconvoluting a plurality of overlapping precursor ion m/z peaks in a binary ion trace.

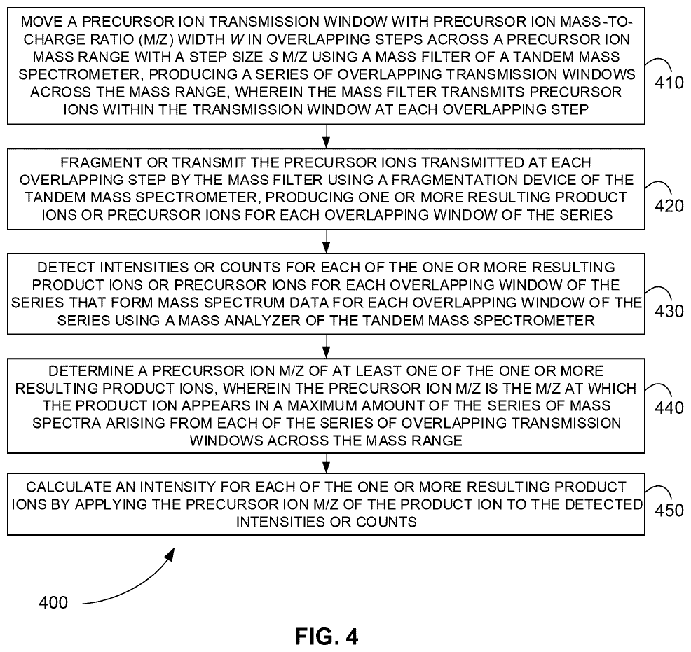

FIG. 4 provides a flowchart demonstrating method 400 in accordance with certain aspects disclosed herein. Particularly, method 400 reflects acquisition and analysis of mass spectra data according to the system depicted in FIG. 1. Operation 410 recites a mass filter of a tandem mass spectrometer employed to obtain a series of overlapping transmission windows and related mass spectral data. Operation 420 proceeds to fragment or transmit the precursor ions transmitted from the mass filter at operation 410. Operation 430 provides detecting the intensity of each product ion formed by the fragmentation operation 420.

Operations 440 and 450 each represent a determination analysis following the data acquisition of steps. In certain aspects, operation 440 can comprise, or consist of forming a binary ion trace similar to binary ion trace 270 of FIG. 2. The binary ion trace can be implemented as a PIU pdf identifying precursor m/z of each product ion detected during the method. PIU pdf as described herein can be generated from mass filter data in certain aspects, wherein the “y-value” is maximized and correlated to a distinct number of product ions. Constructing a binary ion trace as described herein, independent from intensity of any given product ion, carries the advantage of allowing the shape of the resulting binary ion trace to be predictable, and directly related and proportional to the width of the transmission window (W) and step size(S). In this manner, the shape of the binary ion trace can be triangular, with a maximum capped at a certain value independent from intensity of the ion peak. Accordingly, determining a precursor m/z of at least one or more product ions can be limited to a certain “y-value” along the plot similar to plot 260 in FIG. 2. As will be understood by those of skill in the art, any given product ion will appear as having the same m/z in each transmission window in which it appears, and so can only appear in some limited amount of transmission windows across the mass range, as discussed above in reference to FIG. 2.

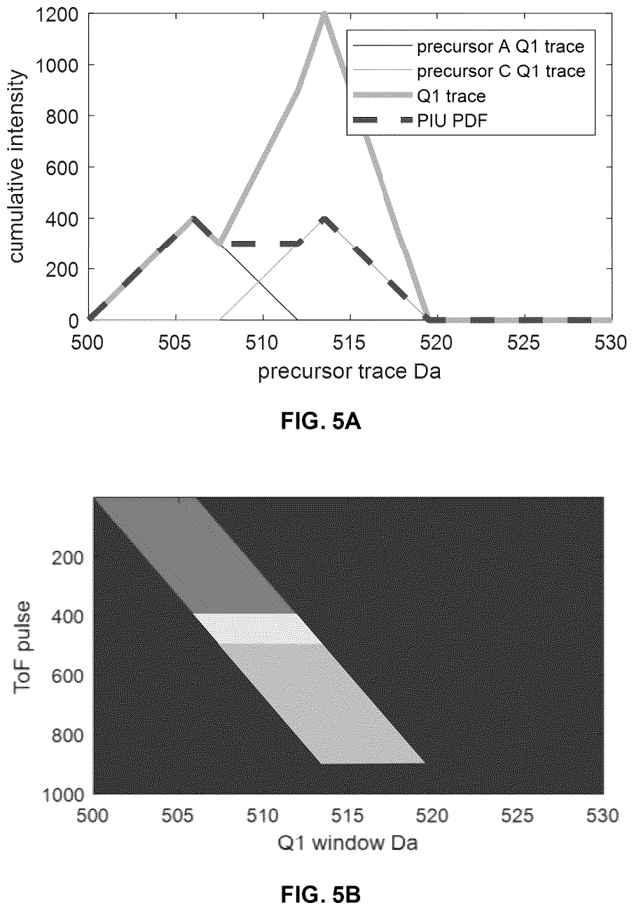

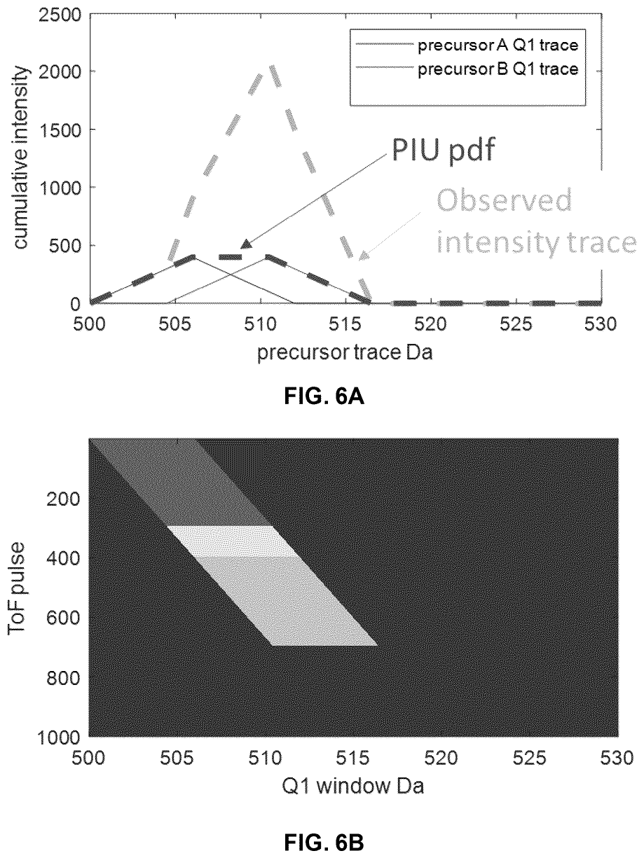

Operation 440 also can comprise deconvoluting overlapping peaks in the binary ion trace having a similar precursor ion m/z, even where the precursors give rise to identical fragment ions. Conventionally, such deconvolution has been achieved by deconstruction of the observed intensity trace, or from preparing a PIU pdf that incorporates intensity data from each product ion into the PIU pdf. Methods contemplated herein can exclude intensity data from the PIU pdf, ensuring that peak shape and size are more consistent between different product ions. Such conformity allows greater confidence in separating overlapping peaks, as shown in FIGS. 5 and 6.

Once each precursor ion has been identified and correlated to its set of product ions, intensity data obtained during operation 430 can be correlated to each of the individual spectra unambiguously, relying on the precursor data previously obtained. Operation 450 of the method represents this relatively straightforward calculation, completing the two-step approach as described above.

FIG. 5A shows a plot of both an observed intensity trace and a PIU pdf for two overlapping precursor ions. The PIU pdf is constructed in accordance with examples described herein, such as plot 260 of FIG. 2, and as described for operation 440 of method 400 above. As shown in FIG. 5A, the relative intensity of the overlapping peaks is skewed in favor of precursor A. For conventional precursor inference methods that incorporate intensity into the precursor inference, (e.g., Q1 trace in FIG. 5A) this overlap can result in a shift in the precursor mass toward the m/z of the more prevalent ion. Noise from the Q1 trace also can create an artificial shoulder that could be falsely attributed to a precursor not actually present in the sample.

In contrast, the PIU PDF described herein allows for each peak to be represented according to its presence in a series of transmission windows, and not relative to its intensity within each transmission window. In this manner each peak is represented in a 1:1 ratio independent of its intensity. This approach also allows for a predictable peak shape independent of intensity, and facilitates more straightforward deconvolution of overlapping peaks. FIG. 5B shows the ToF pulse data and presence of product ions resulting from precursor A and C with the same m/z, shown as being present in a different subset of the series of overlapping transmission windows across the mass range.

FIGS. 6A and 6B provides a further example of the intensity independent PIU pdf compared to the Q1 trace, with more severe overlap than in the example of FIGS. 5A and 5B. As shown, the observed intensity trace for precursors A and B is practically complete, with only a small shoulder between 500 and 505 Da indicating the presence of a product ion formed as a fragment of precursor A. The generated PIU pdf also has more overlap than in the previous example of FIGS. 5A and 5B, but the peaks remain easily distinguishable due to the predictable peak shape and normalized peak ratio.

Correlating product ions to precursors as disclosed herein may also have the benefit of simplifying intensity determinations. Improving the accuracy of precursor determinations and the associated product ions arising from fragmentation of the precursor ions allows the observed intensity to be assigned with reduced error. As stated above, the determination of a binary ion trace separate from intensity transforms the determination into a single-variable solution able to be resolved with far less processing power than conventional methods. The improved accuracy resulting from the binary ion trace determination also effectively transforms the intensity determination into a single-variable solution, because the observed intensity can be mapped onto the known precursors and product ions directly and with greater confidence, having independently conducted the precursor inference. Operations 450 and 440 of method 400 are therefore shown as separate determinations, and representing independent single-variable determinations, in contrast to a single two-variable post-hoc calculation to determine the precursor m/z and intensity of product ions observed during MS/MS methodology.

While the present teachings are described in conjunction with various examples, it is not intended that the present teachings be limited to such examples. On the contrary, the present teachings encompass various alternatives, modifications, and equivalents, as will be appreciated by those of skill in the art.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method for correlating a product ion in a mass spectrum to a precursor ion, the method comprising:
obtaining a series of mass spectra for a sample across a mass range, each of the series of mass spectra having a precursor ion transmission window defined by a width (W) that overlaps with that of at least two of the series of mass spectra by a step size(S); and
determining a precursor ion m/z corresponding to the product ion as an m/z at which the product ion appears in a maximum amount of the series of mass spectra.

2. The method of claim 1, wherein obtaining the series of mass spectra comprises scanning SWATH acquisition in a tandem mass spectrometer.

3. The method of claim 1, wherein each of the precursor transmission windows has a width (W) in a range from 0.1 to 10 Da.

4. The method of claim 1, wherein the step size is in a range from 0.1 Da to 10 Da.

5. The method of claim 1, wherein the step size(S) (S) is constant.

6. The method of claim 1, wherein the series of mass spectra comprises from 10 to 1,000 mass spectra.

7. The method of claim 1, wherein determining a precursor ion m/z comprises constructing a binary ion trace by plotting an amount of the series of mass spectra in which the product ion appears versus an m/z within the precursor transmission window.

8. The method of claim 7, further comprising deconvoluting a plurality of overlapping precursor ion m/z peaks in the binary ion trace.

9. The method of claim 8, wherein deconvoluting the plurality of overlapping precursor ion m/z peaks comprises assigning a triangular shape to each of the plurality of overlapping precursor ion m/z peaks.

10. The method of claim 8, wherein the plurality of overlapping precursor m/z peaks comprises two or three peaks.

11. The method of claim 8, wherein each of the plurality of overlapping precursor m/z peaks has a precursor ion m/z within a range of 0.1 Da.

12. The method of claim 8, wherein a processing requirement for deconvoluting a plurality of overlapping precursor ion m/z peaks is less than that of an otherwise identical method wherein precursor ion m/z is determined by deconvolution of peaks within an intensity trace.

13. The method of claim 8, wherein deconvoluting a plurality of overlapping precursor ion m/z peaks has a resolution that is greater than that of an otherwise identical method wherein precursor ion m/z is determined by deconvolution of peaks from an intensity trace.

14. The method of claim 1, further comprising detecting intensities or counts for the product ion in each precursor transmission window that form the series of mass spectra.

15. The method of claim 14, further comprising forming a cumulative ion intensity trace from the detected intensities or counts.

16. The method of claim 1, wherein determining a precursor ion m/z corresponding to the product ion is independent from product ion intensity data.

17. The method of claim 1, wherein the precursor ion m/z is determined for each of the series of mass spectra in real-time.

18. A method for generating mass spectrometry data comprising:
moving a precursor ion transmission window with precursor ion mass-to-charge ratio (m/z) width W in overlapping steps across a precursor ion mass range with a step size S m/z using a mass filter of a tandem mass spectrometer, producing a series of overlapping transmission windows across the mass range, wherein the mass filter transmits precursor ions within the transmission window at each overlapping step;
fragmenting or transmitting the precursor ions transmitted at each overlapping step by the mass filter using a fragmentation device of the spectrometer, producing one or more resulting product ions for each overlapping window of the series;
detecting intensities or counts for each of the one or more resulting product ions for each overlapping window of the series that form a series of mass spectra, each of the series of mass spectra corresponding to one of the series of overlapping transmission windows;
determining a precursor ion m/z of at least one of the one or more resulting product ions, wherein the precursor ion m/z is the m/z at which the product ion appears in a maximum amount of the series of mass spectra arising from each of the series of overlapping transmission windows across the mass range; and
calculating an intensity for each of the one or more resulting product ions by applying the precursor ion m/z of the product ion to the detected intensities or counts.

19. The method of claim 18, wherein determining the precursor ion m/z comprises deconvoluting the precursor ion m/z of two or more product ions for which intensities or counts are detected at the same m/z.

20. A tandem mass spectrometry system, comprising:
a mass filter of a tandem mass spectrometer that moves a precursor ion transmission window with precursor ion mass-to-charge ratio (m/z) width W in overlapping steps across a precursor ion mass range with a step size S m/z, producing a series of overlapping transmission windows across the mass range, wherein the mass filter transmits precursor ions within the transmission window at each overlapping step;
a fragmentation device of the spectrometer that fragments or transmits the precursor ions transmitted at each overlapping step by the mass filter, producing one or more resulting product ions for each overlapping window of the series;
a mass analyzer of the spectrometer that detects intensities or counts for each of the one or more resulting product ions for each overlapping window of the series that form mass spectrum data for each overlapping window of the series; and
a processor that, instead of storing the mass spectrum data for each overlapping window of the series in a memory device, encodes each unique product ion detected by the mass analyzer in real-time during data acquisition by:
determining a precursor ion m/z for each unique product ion as the m/z at which the product ion appears in a maximum amount of the series of mass spectra arising from each of the series of overlapping transmission windows; and
determining an intensity associated with the unique product ion.
